(19) United States
(12) Patent Application Publication
(10) Pub. No.: US 2013/0312605 A1
(43) Pub. Date: Nov. 28, 2013

(54) GAS PHASE AIR FILTRATION

(71) Applicant: TICONA LLC, (US)

(72) Inventors: Julia HUFEN, Rheinberg (DE); Suresh SUBRAMONIAN, Cary, NC (US); Janine BAUER, Duisburg (DE); Kerstin LUEDTKE, Markkleeberg (DE); Jason SMITH, Cincinnati, OH (US); Dian CHEN, Union, KY (US)

(73) Assignee: TICONA LLC, Florence, KY (US)

(21) Appl. No.: 13/887,868

(22) Filed: May 6, 2013

Related U.S. Application Data
(60) Provisional application No. 61/642,882, filed on May 4, 2012.
(60) Provisional application No. 61/790,938, filed on Mar. 15, 2013.

(51) Int. Cl. B01D 53/04

(52) U.S. Cl. CPC B01D 53/0407
USPC 95/90; 96/153

(57) ABSTRACT

An adsorbent medium for removing gaseous contaminants from air comprises a porous self-supporting filter element produced by sintering particles of polyethylene having a molecular weight greater than 400,000 g/mol as determined by ASTM-D 4020 and an adsorbent. In one embodiment, the filter element comprises a body perforated by a plurality of holes extending in the direction of fluid flow in use and having a diameter of less than 10 mm. In another embodiment, the filter element comprises a panel wherein at least the surface of the panel presented, in use, to the incoming air comprises a plurality of projections. In a further embodiment, the filter element comprises a fibrous web having particles of the adsorbent secured to the web by the sintered polyethylene.

### FIELD

The present invention relates to processes and filters for the gas phase filtration of air.

### BACKGROUND

Good indoor air quality is an important determinant of human health, comfort and productivity and is highly desirable as people spend a significant portion (90%) of their time in homes, offices, shopping centers and in cars. The three techniques used to control contaminants include source reduction, dilution and air cleaning. As building ventilation rates are reduced for energy conservation purposes, air cleaning technologies for the recirculated air are of increasing importance. For example, to save energy costs and improve energy efficiency, buildings are tightly sealed to reduce infiltration and leakage and operated with a higher percentage of recirculated air and limited fresh air supply, sometimes as little as 1.0% and this could result in poor indoor air quality or sick building syndrome.

A variety of filters are used in centralized heating ventilation and air-conditioning (HVAC) systems and in portable air cleaning systems for removing particulates and improving indoor air quality ranging from roughing filters for capturing large particles to HEPA filters for capturing submicron particles at high efficiencies. Such air cleaners are not effective for removal of gaseous contaminants present at the molecular level in the vapor phase.

Gaseous contaminants such as tobacco fumes due to smoking can be easily eliminated with a smoke free environment. Other pollutants such as formaldehyde come from a variety of sources such as off-gassing from pressed wood products and carpets and from secondary sources such as reaction of ozone with other contaminants. Formaldehyde is a carcinogen, an irritant, and a possible source of asthma exacerbation. Removal of such gaseous volatile organic compounds (VOC) and hazardous air pollutants (HAP) is challenging and requires adsorbents such as activated carbon and chemisorbents.

Gas phase air filters capture contaminants by physical adsorption or chemisorption. Physical adsorption or physisorption arises from the intermolecular attraction (van der Waals) of gas or vapor molecules to a surface and the process is reversible due to the relatively weak forces involved. Chemisorption involves the chemical reaction of gas or vapor molecules with reactive agents impregnated into the adsorbent. These impregnates react irreversibly with gases and form stable chemical compounds that are bound to the adsorption media as organic or inorganic salts, or are broken down and released into the air as carbon dioxide or water vapor, or some material more readily adsorbed by other adsorbents. The impregnated materials provide high capacity for gases such as H₂S, HCl, SO₂, Cl₂, etc that are not effectively removed by standard carbon and alumina adsorbents. Potassium permanganate is commonly impregnated on carbon or alumina as it reacts with many common air pollutants, including formaldehyde and sulfur and nitrogen oxides.

Current gas phase air filters comprise granular, pelletized or beaded physi- or chemisorbents arranged in a variety of configurations including multi-pocket bag filters, cartridges, canisters, flat panel filters, shallow and deep pleated filters and modular assemblies. One common configuration uses disposable trays of granular physi- or chemisorbents which are arranged in a zig zag pattern placed in the placed in the airstream and disposed of when expended. While these granular media can be highly effective in removing a broad range of VOCs from air, they are expensive, can impose a high airflow resistance, and have an uncertain lifetime in indoor air applications. Another option is to integrate the sorbent into a fibrous particle filter using a slurry coating process to apply the sorbent powder onto the fibrous media or bonding the sorbent in a 3-dimensional nonwoven fibrous matrix. This tends to reduce the problem of airflow resistance, but the amount of sorbent, and hence the VOC removal capacity, of these filters is limited. Again, the filters are intended for disposal when expended making them a relatively expensive solution.

To obviate the problems associated with existing filters, it has more recently proposed to use self-supporting or structured sorbents, such as extruded monolithic blocks and/or honeycombs made from or coated with an adsorbent material, such as activated carbon. However, the complex fabrication processes and the resultant higher costs of these materials limits widespread use. Moreover, where the adsorbent is deposited (wash coated) in the channels of an inert monolithic support, a honeycomb structure results in lower loading of active sites compared to adsorbent materials in the form of beads or pellets. Also, in the absence of good edge sealing, the possibility exists for fluid leakage at the interface between the monolith and the surrounding support.

There is therefore a continuing need to develop improved self-supporting adsorbent media for removing gaseous contaminants from air.

### SUMMARY

In one aspect, the invention resides in an adsorbent medium for removing gaseous contaminants from air comprising a porous self-supporting filter body produced by sintering a particulate mixture of polyethylene having a molecular weight greater than 400,000 g/mole as determined by ASTM-D 4020 and an adsorbent, and the body can optionally be perforated by a plurality of holes extending in the direction of fluid flow in use and having a diameter of less than 10 mm.

In a further aspect, the invention resides in an adsorbent medium for removing gaseous contaminants from air comprising a porous self-supporting filter panel produced by sintering a particulate mixture of polyethylene having a molecular weight greater than 400,000 g/mole as determined by ASTM-D 4020 and an adsorbent, wherein at least the surface of the panel presented to the incoming air, in use, comprises a plurality of projections and preferably is pleated.

In yet a further aspect, the invention resides in an adsorbent medium for removing gaseous contaminants from air comprising a porous self-supporting filter element comprising a fibrous web and particles of an adsorbent secured to the web by a binder comprising polyethylene having a molecular weight greater than 400,000 g/mole as determined by ASTM-D 4020.

Typically, the filter has a porosity of at least 35%.

Conveniently, the polyethylene particles have a molecular weight up to 10×10⁶ g/mol, for example from 4×10⁵ g/mol to 8×10⁶ g/mol, as determined by ASTM-D 4020.

Generally, the polyethylene particles have an average particle size, d₅₀, between 1 and 500 μm, such as between 30 and 350 μm. Conveniently, the particles have a monomodal molecular weight distribution or may have a multimodal molecular weight distribution.

Generally, the polyethylene particles have a bulk density between 0.1 and 0.5 g/ml.

In one embodiment, the adsorbent comprises a physisorbent selected from at least one of activated carbon, carbon molecular sieve, diatomaceous earth, silica, alumina and zeolite. In another embodiment, the adsorbent comprises a chemisorbent selected from at least one of potassium permanganate, potassium carbonate, potassium hydroxide, potassium iodide, calcium carbonate, calcium sulfate, sodium carbonate, sodium hydroxide, calcium hydroxide, ion exchange resins, titanium silicates, titanium oxides, powdered metals and metal oxides and hydroxides. Combinations of physisorbents and chemisorbents can also be used.

Conveniently, the adsorbent comprises activated carbon having a bulk density of between 0.3 and 0.8 g/ml and a BET surface area of about 500 to about 2000 m²/g.

Generally, the weight ratio of powdered adsorbent to polyethylene binder in the sintered mixture is from 99:1 to 1:99, for example from 90:10 to 50:50, such as from 80:20 to 60:40, and typically is about 75:25.

In another embodiment the invention is directed to an adsorbent medium for removing gaseous contaminants from air comprising a porous self-supporting filter body produced by sintering a particulate mixture of polyethylene having a molecular weight greater than 400,000 g/mol but less than 750,000 g/mol as determined by ASTM-D 4020 and an adsorbent having a particle size range from 0.14 mm to 1.7 mm, or from 0.2 mm to 1.7 mm.

### BRIEF DESCRIPTION OF THE DRAWINGS

FIG. 1 is a graph of pressure drop against velocity of air for various filters when used in the performance test described in the Examples.

FIG. 2 is a bar graph comparing the initial breakthrough time for various filters when used in the removal of toluene from air according to the performance test described in the Examples.

FIG. 3 is a bar graph comparing the 30% breakthrough time for various filters when used in the removal of toluene from air according to the performance test described in the Examples.

FIG. 4 is a graph comparing the toluene removal efficiency with time on stream for various filters when used in the removal of toluene from air according to the performance test described in the Examples.

FIG. 5 is a graph comparing the amount of toluene removed with time on stream for various filters when used in the removal of toluene from air according to the performance test described in the Examples.

FIG. 6 is a graph comparing the toluene removal capacity with time on stream for the filter coupon weight.

FIG. 7 is a graph comparing toluene removal capacity as a function of percent carbon weight.

### DETAILED DESCRIPTION OF THE EMBODIMENTS

Described herein is an adsorbent medium for use in the removal of gaseous contaminants from the air. The adsorbent medium comprises a self-supporting filter element which contains one or more physisorbents or chemisorbents and one or more binders comprising particulate polyethylene having a molecular weight greater than 400,000 g/mole and generally up to 10×10⁶ g/mol, for example from 4×10⁵ g/mol to 8×10⁶ g/mol, and advantageously from 400,000 g/mol to 750,000 g/mol, as determined by ASTM-D 4020. The polyethylene powder may have a monomodal molecular weight distribution or may have a multimodal, generally bimodal, molecular weight distribution. The particle size of the polyethylene powder used to produce the filter elements can vary significantly but in general the powder has an average particle size, d₅₀, between 1 and 500 μm, such as between 30 and 350 μm, for example from 30 to 200 p.m. Where the as-synthesized powder has a particle size in excess of the desired value, the particles can be ground to the desired particle size. The bulk density of the polyethylene powder is typically is between 0.1 and 0.5 g/ml, such as between 0.2 and 0.45 g/ml. Mixtures of two or more high and/or ultra high and/or very high molecular weight polyethylene binders having, for example, different molecular weights and/or different particle sizes and/or different bulk densities, can also be used.

The high molecular weight polyethylene powder used to produce the sorbent medium is typically produced by the catalytic polymerization of ethylene monomer or ethylene-1-olefin co-monomers, the 1-olefin content in the final polymer being less or equal to 10% of the ethylene content, with a heterogeneous catalyst and an organo aluminum- or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid wall fouling and product contamination.

Suitable catalyst systems include but are not limited to Ziegler-Natta type catalysts. Typically Ziegler-Natta type catalysts are derived from a combination of transition metal compounds of Group 4 to 8 of the Periodic Table and alkyl- or hydrid derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum- or magnesium compounds, such as for example but not limited to aluminum- or magnesium alkyls and titanium-, vanadium- or chromium halides or esters. The heterogeneous catalyst may be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium(IV) compound and in the range of 0.01 and 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, like for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium-, magnesium- and zinc stearate.

Optionally, other catalysts such as Phillips catalysts, metallocenes and post metallocenes may be employed. Generally a cocatalyst such as alumoxane or alkyl aluminum or alkyl magnesium compound is also employed. For example, U.S. Patent Application Publication No. 2002/0040113 to Fritzsche et al., the entire contents of which are incorporated herein by reference, discusses several catalyst systems for producing ultra-high molecular weight polyethylene. Other suitable catalyst systems include Group 4 metal complexes of phenolate ether ligands such as are described in International Patent Publication No. WO2012/004675, the entire contents of which are incorporated herein by reference.

In addition to the high molecular weight polyethylene binder, each filter element contains one or more physisorbents and/or one or more chemisorbents. Depending on the target contaminant(s) suitable physisorbents include one or more of activated carbon, carbon molecular sieve, diatomaceous earth, silica, alumina, and zeolites. Suitable chemisorbents include one or more of potassium permanganate, potassium carbonate, potassium hydroxide, potassium iodide, calcium carbonate, calcium sulfate, sodium carbonate, sodium hydroxide, calcium hydroxide, ion exchange resins, titanium silicates, titanium oxides, powdered metals and metal oxides and hydroxides. Combinations of physisorbents and chemisorbents can also be used.

A preferred adsorbent comprises comprises activated carbon having a bulk density of from 0.3 to 0.8 g/ml, a particle size from about 5 to about 2000 μm and a BET surface area of about 500 to about 2000 m²/g, such as about 800 to about 1500 m²/g. In some cases, it may be desirable to employ as the adsorbent activated carbon having two or more particle sizes, for example from about 20% to about 80% of a first activated carbon powder having a particle size from about 5 to about 2000 μm and a remainder of a second activated carbon powder having a different particle size from about 5 to about 2000 μm.

Depending on the construction and intended operation of the filter element, the weight ratio of polyethylene particles to the weight ratio of adsorbent in each filter element may vary from 1:99 to 99:1, more typically from 50:50 to 10:90.

In a first embodiment, the filter element employed herein comprises a porous self-supporting composite produced by sintering a particulate mixture of polyethylene having a molecular weight greater than 400,000 g/mol as determined by ASTM-D 4020 and the desired adsorbent. The particulate mixture may also contain additives such as lubricants, dyes, pigments, antioxidants, fillers, processing aids, light stabilizers, neutralizers, antiblocks, and antiviral and/or antimicrobial agents, such as silver salts.

The sintered composite may be formed by a free sintering process which involves introducing the particulate mixture comprising the polyethylene polymer and the adsorbent into either a partially or totally confined space, e.g., a mold, and subjecting the mixture to heat sufficient to cause the polyethylene particles to soften, expand and contact one another. Suitable processes include compression molding and casting. The mold can be made of steel, aluminum or other metals. Depending on the shape of the mold, the sintered composite may be in the form of a cartridge, canister or a flat or shaped panel.

Sintering processes are well-known in the art. The mold is heated to the sintering temperature, which is normally in the range of about 100° C. to 300° C., such as 140° C. to 300° C., for example 140° C. to 240° C. The mold is typically heated in a convection oven, hydraulic press or by infrared heaters. The heating time will vary and depend upon the mass of the mold and the geometry of the molded article. Typical heating time will lie within the range of about 5 to about 300 minutes, more typically in the range of about 15 minutes to about 100 minutes. The mold may also be vibrated to ensure uniform distribution of the powder.

During sintering, the surface of individual polymer particles fuse at their contact points forming a porous structure. The polymer particles coalesce together at the contact points due to the diffusion of polymer chains across the interface of the particles. The interface eventually disappears and mechanical strength at the interface develops. Subsequently, the mold is cooled and the porous article removed. The cooling step may be accomplished by conventional means, for example it may be performed by blowing air past the article or the mold, or contacting the mold with a cold fluid. Upon cooling, the polyethylene typically undergoes a reduction in bulk volume. This is commonly referred to as “shrinkage.” A high degree of shrinkage is generally not desirable as it can cause shape distortion in the final product.

Pressure may be applied during the sintering process, if desired. However, subjecting the particles to pressure causes them to rearrange and deform at their contact points until the material is compressed and the porosity is reduced. In general, therefore, the sintering process employed herein is conducted in the absence of applied pressure.

The filter element of the first embodiment not only has porosity resulting from the sintering process but also can optionally be perforated by a plurality of holes extending in the direction of intended fluid flow in use, wherein the holes have a diameter of less than 10 mm. These holes can be produced during the sintering/molding process or created after fabrication, for example by drilling. The purpose of the holes is to provide gas flow channels to reduce the pressure drop through the filter. At low gas velocity, the flow will be laminar with low pressure drop, whereas at high gas velocity the flow will be turbulent with extensive and continuous mixing along the flow path. In addition to the straight flow channels provided by the perforations, the porosity of the filter body also provides secondary tortuous paths enabling access to active adsorbent sites throughout the structure.

In a second embodiment, the filter element comprise a porous self-supporting panel which, in use, presents an undulating, preferably pleated, surface to the incoming air to be filtered. In this case, the particulate mixture of polyethylene and adsorbent can be formed into the required panel by a continuous sintering process in which the adsorbent powder and resin binder are blended in a mixer and loaded into a hopper. The mixture from the hopper is then fed to a moving conveyor belt at a steady preset rate and forwarded by the conveyor between two sets of heated rolls with a preset gap (based on sheet thickness) that heat the resin to the softening temperature and cause point bonding of the adsorbent powder to form a continuous sheet. The rollers apply low to moderate pressure, preferably zero to low pressure, to the mixture during the sintering process to produce a continuous sintered sheet. After exiting the rollers, the sheet is cooled and wound onto a roller or slit into sheets. The sheet can then be mounted in a wire grid frame to produce the required pleated panel.

In a third embodiment, the filter element comprises an open fibrous web and particles of an adsorbent secured to the web by the polyethylene binder described above. The fibrous web may comprise a carded web of staple fiber, a dry laid or wet laid fiber web, or a spun bound or melt blown polymer web where the adsorbent particles and resin binder are uniformly distributed by vibration and the web is heated to soften the resin and bond the particles to the web. In another embodiment, the required filter element is produced by applying a homogeneous mixture of the sorbent and resin binder to the fibrous web and then exposing the combination to heat to cause the resin to bond to the sorbent and the composite particles to bond to the fiber. In a further embodiment, preformed composite particles comprising resin binder and active sorbent are uniformly distributed over the web and are bonded to the web by the application of heat.

Generally, the filters employed herein should have a high porosity, such as at least 35% and preferably at least 40%, and a low pressure drop, such as less than 800 Pa, for example less than 300 Pa. In general the filters should have a flexural strength as determined in accordance with DIN ISO 178 of at least 0.5 MPa.

The invention will now be more particularly described with reference to the following non-limiting Examples.

In the Examples, and the remainder of the specification, the following tests are used to measure the various parameters cited herein.

Particle size measurements cited herein are average particle size vales and are obtained by a laser diffraction method according to ISO 13320.

Polyethylene powder bulk density measurements are obtained according to DIN 53466.

Activated carbon bulk density measurements are obtained according to ASTM D2854.

Activated carbon BET surface area measurements are obtained according to DIN 66131.

Porosity values are determined by mercury intrusion porosimetry according to DIN 66133.

Average pore size values are determined according to DIN ISO 4003.

Pressure drop values are measured using a sample of the porous article having a diameter of 48 mm, a depth of 6.35 mm and an airflow rate of 14.15 liter/min or 28.3 liter/minr and measuring the drop in pressure across the depth of the sample.

### Examples 1 to 12

The commercial HMW, VHMW and UHMW PE resins listed in Table 1 with a range of MW, bulk densities, particle sizes and shapes are used to fabricate sintered filters with a range of pore size, porosity and pressure drop values.

TABLE 1

| | Exam- | Exam- | Exam- | | | | | | | Example | Example | Example |
|---|---|---|---|---|---|---|---|---|---|---|---|---|
| Property | ple 1 | ple 2 | ple 3 | Example 4 | Example 5 | Example 6 | Example 7 | Example 8 | Example 9 | 10 | 11 | 12 |
| MW | 4 | 7.3 | 5 | 4 | 1.7 | 7 | 4 | 0.6 | 0.7 | 0.5 | 0.5 | 0.47 |
| (10⁶ g/mol) | | | | | | | | | | | | |
| Avg. d50 | 35 | 60 | 120 | 140 | 150 | 175 | 280 | 400 | 120 | 118 | 220 | 120 |
| Particle Size | | | | | | | | | | | | |
| (μm) | | | | | | | | | | | | |
| Bulk Density | >0.23 | >0.40 | >0.40 | >0.23 | >0.40 | >0.40 | >0.40 | >0.35 | >0.40 | >0.40 | >0.40 | >0.23 |
| (g/ml) | | | | | | | | | | | | |

### Filter Samples

Sintered filter coupons were produced from blends of 25 wt % of the PE resins having the properties described in Table 2 with 75 wt % of activated carbon supplied by Jacobi Carbons as EcoSorb® CS having surface areas of 1000 m²/g, apparent densities of 470-530 kg/m³ and the particle sizes indicated in the table. A Comparative Filter was produced using only EcoSorb® CS having a particle size of 3360 μm×6730 μm, in the absence of any resin binder. In all cases the filter coupons were 0.25 inch thick in the intended direction of flow.

TABLE 2

| | Resin/carbon | | PE Bulk | | |
|---|---|---|---|---|---|
| | blend by | PE Mol. | Density | PE d₅₀ | Carbon mesh |
| Filter | weight | Wt. | (g/mL) | (μm) | (μm) |
| 1 | 25/75 | 4 × 10⁶ | 0.23 | 125 | 297 × 149 |
| 2 | 25/75 | 4.7 × 10⁵ | 0.23 | 120 | 297 × 149 |
| 3 | 25/75 | 4.7 × 10⁵ | 0.23 | 120 | 1680 × 595 |
| 4 | 25/75 | 4.7 × 10⁵ | 0.23 | 120 | 595 × 210 |
| 5 | 15/85 | 4.7 × 10⁵ | 0.23 | 120 | 595 × 210 |
| Comp. | 0/100 | N/A | N/A | N/A | 6730 × 3360 |
| Filter | | | | | |

The properties of the resultant filters are summarized in Table 3.

TABLE 3

| | | | Activated | Media | Media |
|---|---|---|---|---|---|
| | Media | Media Weight | Carbon Net | depth | Diameter |
| Filter | Form | (g) | Weight (g) | (mm) | (mm) |
| 1 | coupon | 4.04 | 3.03 | 6.35 | 48 |
| 2 | coupon | 3.99 | 2.99 | 6.35 | 48 |
| 3 | coupon | 6.43 | 4.82 | 6.35 | 48 |
| 4 | coupon | 5.74 | 4.31 | 6.35 | 48 |
| 5 | coupon | 5.77 | 4.90 | 6.35 | 48 |
| Comp. | grain | 9.05 | 9.05 | 6.35 | 48 |
| Filter | | | | | |

### Performance Testing Data

Filters 1-5 and the Comparative Filter were tested based on ASHRAE Std. 145.1-2008. The samples were exposed to a toluene challenge gas with the concentration of 320 ppb under flow rate at 14.15 liter/min, temperature at 23° C. and relative humidity at 48% RH. The inlet and outlet challenge gas concentrations are measured and recorded for use in determining media removal efficiencies and capacities.

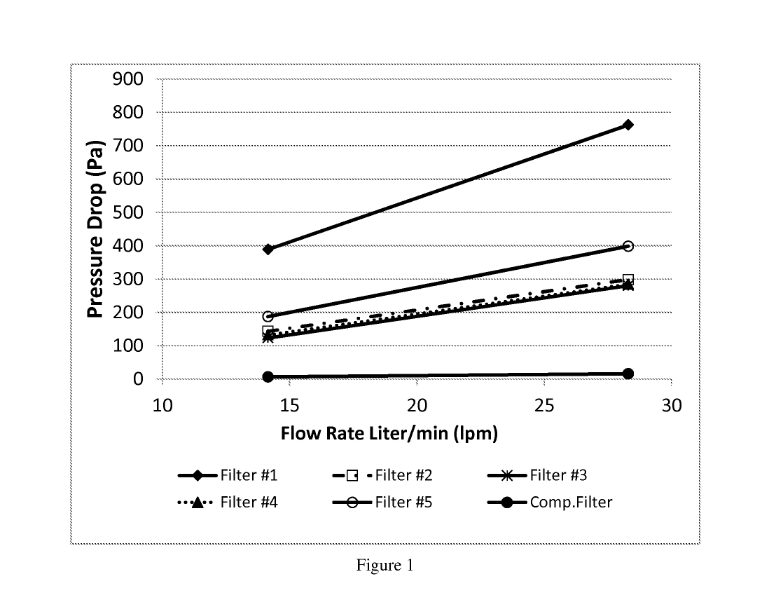

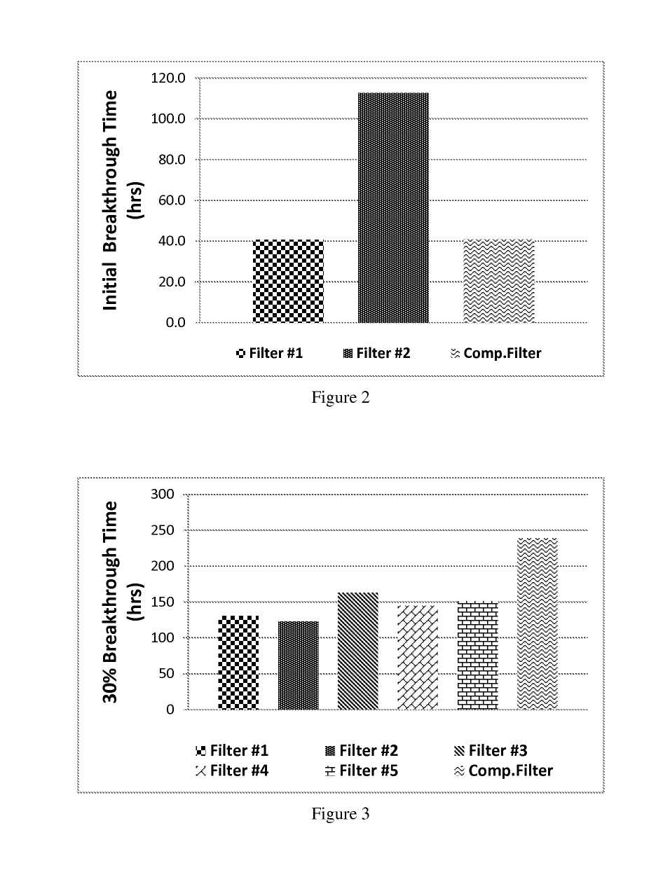

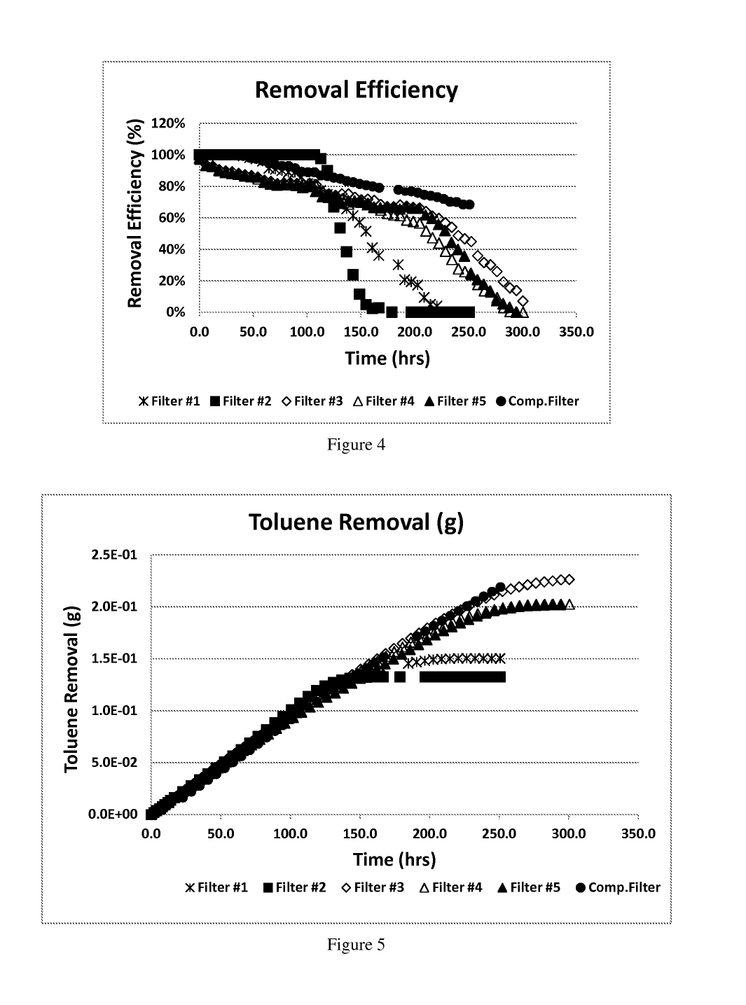

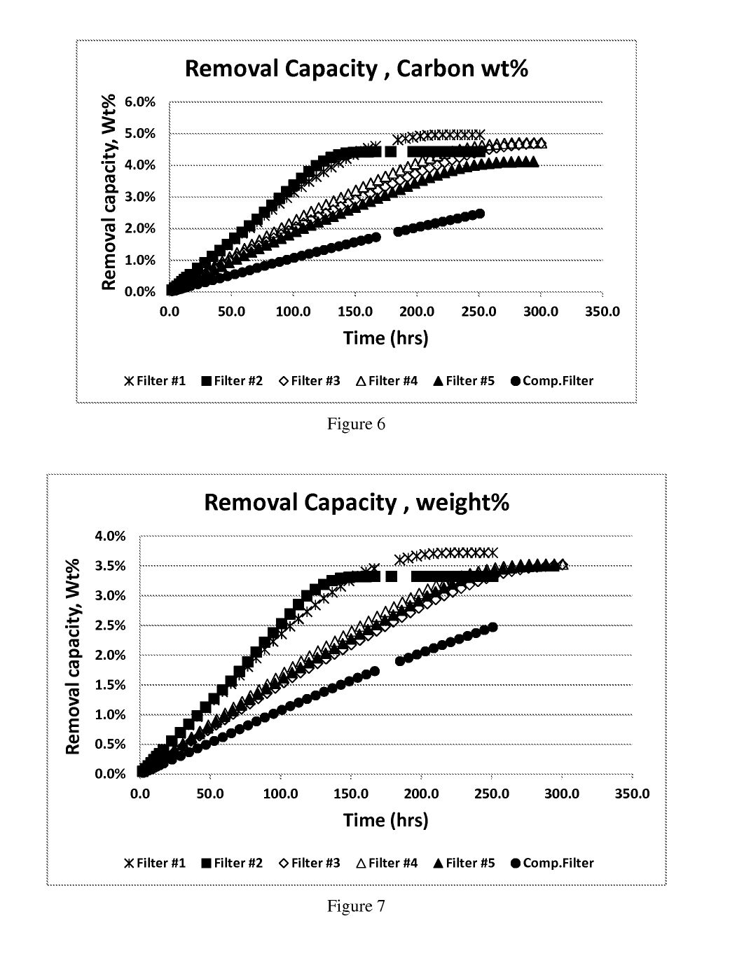

The results are shown in FIGS. 1 to 7 and show that, although the sintered carbon/PE filters exhibited a higher pressure drop than the activated carbon filter, they had a longer initial breakthrough time (particularly Filter 2) and a higher toluene removal capacity. Filter 2 also exhibited the longest period of 100% toluene removal efficiency. However, Filter 1 had a somewhat longer 30% breakthrough time, which is the time necessary for the toluene impurity concentration on the outlet side of the filter to reach 30% of the challenge gas concentration.

1. An adsorbent medium for removing gaseous contaminants from air comprising a porous self-supporting filter body produced by sintering a particulate mixture of polyethylene having a molecular weight greater than 400,000 g/mol as determined by ASTM-D 4020 and an adsorbent, wherein the body is optionally perforated by a plurality of holes extending in the direction of fluid flow in use and having a diameter of less than 10 mm.

2. The adsorbent medium of claim 1, wherein the polyethylene particles have an average particle size, d₅₀, from 1 to 500 μm.

3. The adsorbent medium of claim 1, wherein the polyethylene particles have a bulk density between 0.1 and 0.5 g/ml.

4. The adsorbent medium of claim 1, wherein the weight ratio of powdered adsorbent to polyethylene binder in the sintered mixture is from 99:1 to 1:99.

5. The adsorbent medium of claim 6, wherein the weight ratio of powdered adsorbent to polyethylene binder in the sintered mixture is from 80:20 to 60:40.

6. The adsorbent medium of claim 1, wherein the polyethylene has a molecular weight up to 10×10⁶ g/mol.

7. The adsorbent medium of claim 9, wherein the polyethylene has a molecular weight from 4×10⁵ g/mol to 7.5×10⁵ g/mol, as determined by ASTM-D 4020.

8. The adsorbent medium of claim 1, wherein the adsorbent comprises a physisorbent selected from at least one of activated carbon, carbon molecular sieve, diatomaceous earth, silica, alumina and zeolite.

9. The adsorbent medium of claim 1, wherein the adsorbent comprises a chemisorbent selected from at least one of potassium permanganate, potassium carbonate, potassium hydroxide, potassium iodide, calcium carbonate, calcium sulfate, sodium carbonate, sodium hydroxide, calcium hydroxide, ion exchange resins, titanium silicates, titanium oxides, powdered metals and metal oxides and hydroxides.

10. The adsorbent medium of claim 11, wherein the adsorbent comprises activated carbon.

11. The adsorbent medium of claim 1, wherein the filter has a porosity of at least 35%.

12. An adsorbent medium for removing gaseous contaminants from air comprising a porous self-supporting filter panel produced by sintering a particulate mixture of polyethylene having a molecular weight greater than 400,000 g/mole as determined by ASTM-D 4020 and an adsorbent, wherein at least the surface of the panel presented, in use, to the incoming air comprises a plurality of projections.

13. An adsorbent medium for removing gaseous contaminants from air comprising a porous self-supporting filter element comprising a fibrous web and particles of an adsorbent secured to the web by a binder comprising polyethylene having a molecular weight greater than 400,000 g/mole as determined by ASTM-D 4020.

14. An adsorbent medium for removing gaseous contaminants from air comprising a porous self-supporting filter body produced by sintering a particulate mixture of polyethylene having a molecular weight greater than 400,000 g/mol but less than about 750,000 g/mol as determined by ASTM-D 4020 and an adsorbent having a particle size range from about 0.14 mm to about 1.7 mm.

15. The adsorbent medium of claim 14, which has a pressure drop of less than 400 Pa at an air flow of 28.3 L/min.

16. The adsorbent medium of claim 14, wherein the adsorbent particle size range is from 0.2 mm to 1.7 mm.

17. A process for removing gaseous contaminants from air comprising passing contaminated air through an adsorbent medium comprising a porous self-supporting filter body produced by sintering a particulate mixture of polyethylene having a molecular weight greater than 400,000 g/mol as determined by ASTM-D 4020 and an adsorbent, wherein the body is optionally perforated by a plurality of holes extending in the direction of fluid flow in use and having a diameter of less than 10 mm.
